(19) United States
(12) Patent Application Publication
(10) Pub. No.: US 2014/0085162 A1
(43) Pub. Date: Mar. 27, 2014

(54) LOOP ANTENNA

(71) Applicants: Industrial Cooperation Foundation of Chonbuk National University, Jeollabuk-do (KR); Electronics and Telecommunications Research Institute, Daejeon (KR)

(72) Inventors: Won Kyu CHOI, Daejeon (KR); Jong-Suk Chae, Daejeon (KR); Ji-Hoon Bae, Daejeon (KR); Seung-Hwan Jeong, Jeollabuk-do (KR); Chan-Won Park, Daejeon (KR); Cheol Sig Pyo, Daejeon (KR); Hae-Won Son, Jeollabuk-do (KR)

(21) Appl. No.: 13/920,160

(22) Filed: Jun. 18, 2013

(30) Foreign Application Priority Data
Sep. 26, 2012 (KR) 10-2012-0107399

(51) Int. Cl. H01Q 7/00

(52) U.S. Cl. CPC H01Q 7/00
USPC 343/867

(57) ABSTRACT

A loop antenna includes first and second loops that are formed with respective conductive wires. In this case, the second loop is formed with a double loop having current paths of opposite directions.

### CROSS-REFERENCE TO RELATED APPLICATION

This application claims priority to and the benefit of Korean Patent Application No. 10-2012-0107399 filed in the Korean Intellectual Property Office on Sep. 26, 2012, the entire contents of which are incorporated herein by reference.

### BACKGROUND OF THE INVENTION

(a) Field of the Invention

The present invention relates to a loop antenna. More particularly, the present invention relates to a loop antenna that is mounted and used in a reader of a radio frequency identification (RFID) system using an inductive coupling method.

(b) Description of the Related Art

An RFID system is formed with a tag and a reader, wherein the tag is a transponder and the reader is an interrogator. When an object that the tag is attached to is located at a read zone of the reader, the reader sends an interrogation to the tag, and the tag responds to the interrogation of the reader.

In a passive RFID system using inductive coupling, antennas of a reader and a tag have a form of a loop antenna and are mutually coupled through a sequentially changing magnetic field. After the reader antenna generates a strong magnetic field at a periphery, the reader antenna forwards a signal and power to the tag antenna by an inductive coupling method. In order to forward information of the tag that is stored at an internal memory thereof to the reader, the tag performs load modulation that changes internal impedance thereof. Load modulation is a method of forwarding tag information by changing coupled impedance that is forwarded to the reader antenna by changing load impedance of the tag antenna that is inductive-coupled to the reader antenna.

In general, a passive RFID tag is formed with an antenna and a tag chip, and load impedance of a tag antenna is the same as input impedance of the tag chip. In order to forward data, tag chip impedance repeats two states of low impedance and high impedance.

In a passive RFID system using inductive coupling, a tag antenna induces an electromotive force from an AC magnetic field that is transmitted from a reader antenna and supplies power to a tag. For a normal operation of the tag, an electromotive force that is induced to the tag antenna should be a specific threshold or more. The electromotive force that is induced to the tag antenna is changed according to a mutual position and direction of the reader antenna and the tag antenna.

FIG. 1 is a diagram illustrating a general structure of a reader antenna that is used for inductive coupling, and FIG. 2 is a diagram illustrating a magnetic field in a cross-section II-II of FIG. 1. In FIG. 2, an arrow represents a direction of a magnetic field.

As shown in FIG. 1, a reader antenna 10 that is used for inductive coupling has a form of a loop antenna forming a loop shape by winding a conductive wire 11 one time or more in a circular or quadrangular form.

Referring to FIG. 2, in an immediate upper portion and lower portion of the conductive wire 11 of the reader antenna, a magnetic field m1 occurs in a horizontal direction of a loop surface, and in a central portion of the reader antenna 10, a magnetic field m2 occurs in a vertical direction of a loop surface.

In this case, when appropriately adjusting a gap between conductive wires 11, a horizontal magnetic field may be formed in a relatively wide area on the conductive wire, but in a central portion of the reader antenna 10, a magnetic field of a vertical direction always occurs. Therefore, as shown in FIG. 2, when a loop surface of tag antennas 21, 22, and 23 is located in a vertical direction to a loop surface of the reader antenna 10, a strong electromotive force is induced in the tag antenna 21 and 23, but a weak electromotive force is induced to the tag antenna 22 that is located at a central portion of the reader antenna 10 and thus the tag may not operate.

### SUMMARY OF THE INVENTION

The present invention has been made in an effort to provide a loop antenna having advantages of generating a uniform horizontal magnetic field on a loop surface of a reader antenna in order to recognize a tag in an entire area, even if a loop surface of a tag antenna is located in a vertical direction to the loop surface of the reader antenna.

An exemplary embodiment of the present invention provides a loop antenna. The loop antenna includes: a first loop that is formed with one conductive wire; and a second loop that is formed with another conductive wire and that partially intersects the first loop. The second loop forms a current path having the same magnitude and an opposite phase to that of the first loop.

The second loop may have a figure-8 shape.

The second loop may include a double loop forming a current path of opposite directions.

The first loop and the second loop may be formed with a single coil or multiple coils.

The loop antenna may further include first and second voltage sources that alternately supply a power supply signal to the first loop and the second loop, respectively.

Another embodiment of the present invention provides a loop antenna, including: a first loop that is formed with one conductive wire; a second loop that forms a double loop having a current path of an opposite direction with another conductive wire and that partially intersects the first loop; and a voltage source that alternately supplies a power supply signal to each of the first loop and the second loop.

### BRIEF DESCRIPTION OF THE DRAWINGS

FIG. 1 is a diagram illustrating a general structure of a reader antenna that is used for inductive coupling.

FIG. 2 is a diagram illustrating a magnetic field in a cross-section II-II of FIG. 1.

FIG. 3 is a diagram illustrating a loop antenna according to an exemplary embodiment of the present invention.

FIG. 4 is a diagram illustrating a magnetic field in a cross-section IV-IV of FIG. 3.

FIG. 5 is a diagram illustrating a loop antenna for minimizing interference between two loops of FIG. 3.

FIG. 6 is a diagram illustrating a loop antenna according to another exemplary embodiment of the present invention.

FIGS. 7 and 8 are each diagrams illustrating an exemplary variation of the loop antenna of FIG. 6.

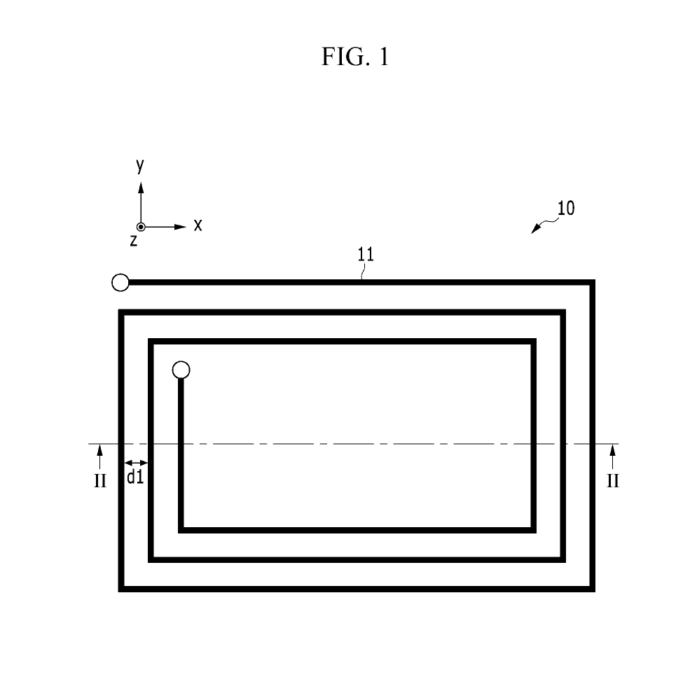

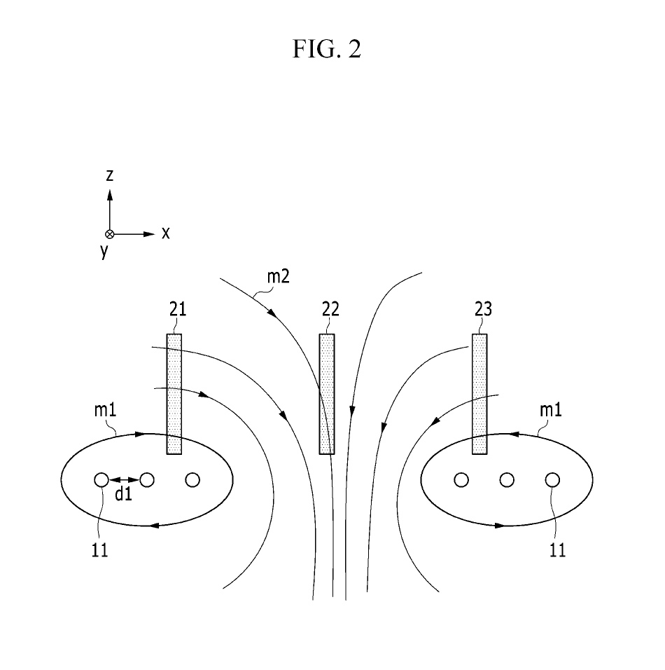

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a loop antenna according to an exemplary embodiment of the present invention will be described in detail with reference to the drawings.

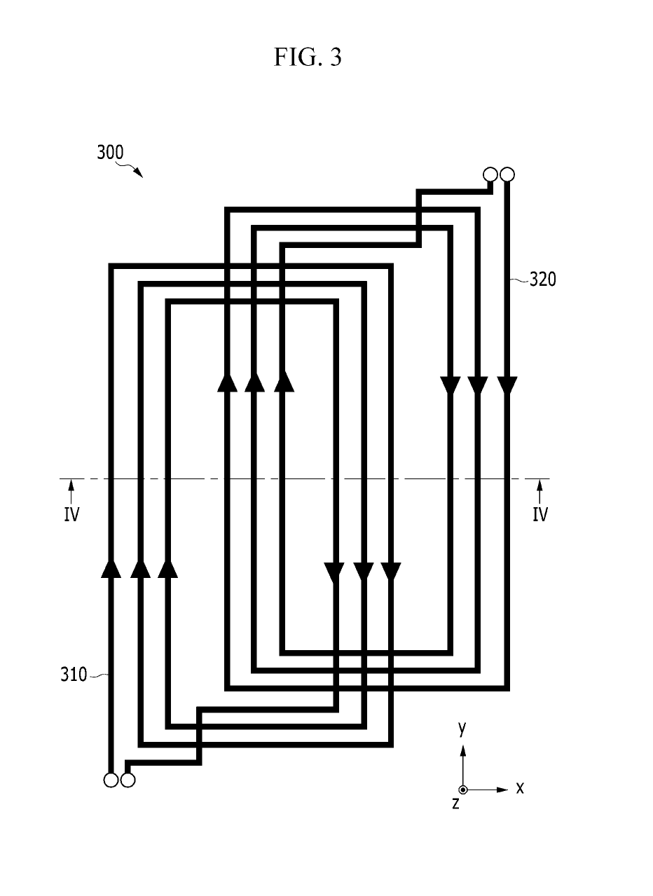

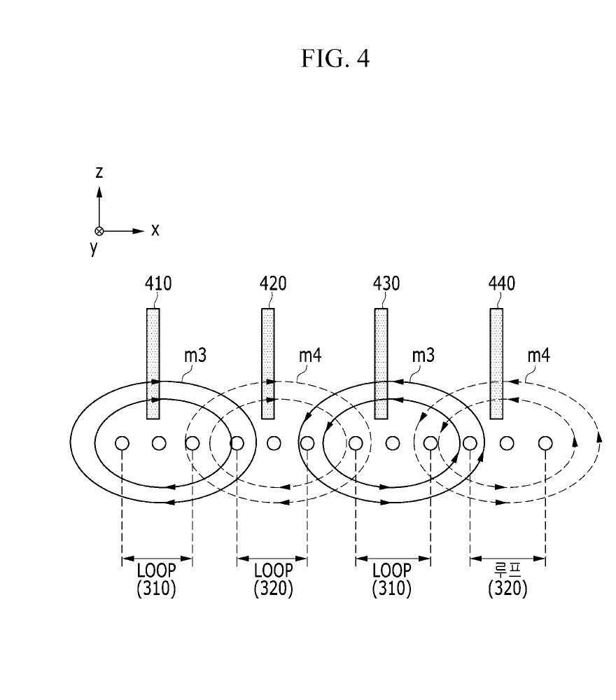

FIG. 3 is a diagram illustrating a loop antenna according to an exemplary embodiment of the present invention, and FIG. 4 is a diagram illustrating a magnetic field in a cross-section IV-IV of FIG. 3. In FIG. 4, an arrow represents a direction of a magnetic field.

Referring to FIG. 3, a loop antenna 300 includes two loops 310 and 320.

The loops 310 and 320 are each formed by winding one or more times in a circular or quadrangular form.

The two loops 310 and 320 are crossed, and a power supply signal is sequentially alternately applied to the two loops 310 and 320.

When a power supply signal is applied to the loop 310, a magnetic field m3 is generated in a horizontal direction of a loop surface on a conductive wire of the loop 310, and when a power supply signal is applied to the loop 320, a magnetic field m4 is generated in a horizontal direction of a loop surface on a conductive wire of the loop 320.

That is, by alternately supplying power to two crossed loops 310 and 320, a horizontal magnetic field sequentially intersects on an entire loop of the reader antenna 300, and resultantly a horizontal magnetic field is uniformly formed on an entire loop surface of the reader antenna 300.

Therefore, as shown in FIG. 4, when the tag antennas 410, 420, 430, and 440 are located in a vertical direction of a loop surface of the loop antenna 300, a reader having the loop antenna 300 can recognize the tag antenna 430 in a vertical direction to a loop surface in a central portion of the tag antenna 420 and the loop 320 that are located in a vertical direction of a loop surface in a central portion of the loop 310 as well as the tag antennas 410 and 440.

However, for a normal operation of the reader antenna that is shown in FIG. 3, when a power supply signal is applied to the loop 310, the loop 320 should be in an open state. Otherwise, an induction current flows to the loop 320 due to interference between the loops 310 and 320, and the induction current disturbs the loop 310 horizontal magnetic field from forming on a conductive wire thereof. Therefore, intensity of an entire horizontal field is weakened, or space distribution of a horizontal magnetic field is distorted and thus a sequentially crossing horizontal magnetic field cannot be formed. Similarly, when a power supply signal is applied to the loop 320, if the loop 310 is in an open state, interference between loops can be reduced.

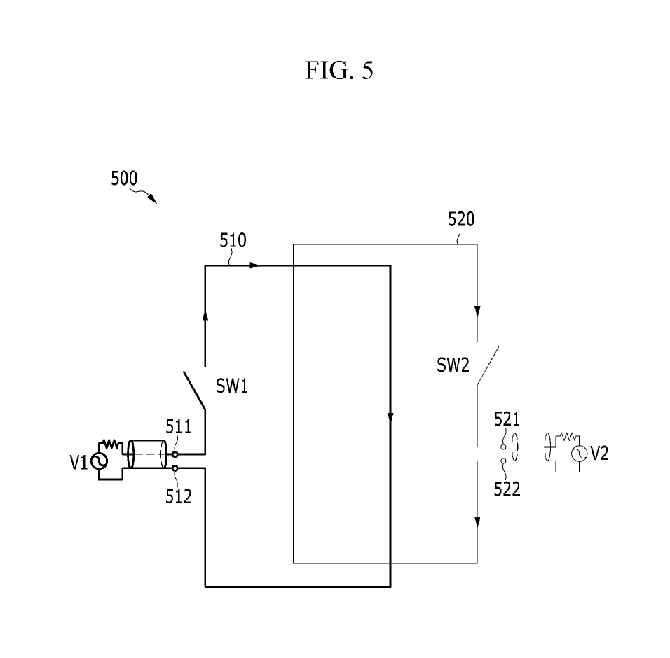

FIG. 5 is a diagram illustrating a loop antenna for minimizing interference between two loops of FIG. 3.

Referring to FIG. 5, a loop antenna 500 includes two crossed loops 510 and 520, switches SW1 and SW2, and voltage sources V1 and V2.

The switch SW1 is connected to a conductive wire forming the loop 510, and the switch SW2 is connected to a conductive wire forming the loop 520. The switches SW1 and SW2 are turned on/off according to a switch control signal.

The voltage source V1 that supplies a power supply signal is connected between input and output terminals 511 and 512 of the loop 510, and the voltage source V2 that supplies a power supply signal is connected between input and output terminals 521 and 522 of the loop 520.

When a power supply signal is supplied to the loop 510 by the voltage source V1, a switch control signal is applied to the switch SW2 to open the switch SW2 of the loop 520. In contrast, when a power supply signal is supplied to the loop 520 by the voltage source V2, a switch control signal is applied to the switch SW1 to open the switch SW1 of the loop 510. Therefore, when a power supply signal is supplied to the loop 510 by the voltage source V1, if a current does not flow to the loop 520 and if a power supply signal is supplied to the loop 520 by the voltage source V2, a current does not flow to the loop 520, and thus interference between two crossed loops 510 and 520 can be reduced.

However, there is a problem that a switch control signal for controlling the switches SW1 and SW2, excluding the voltage sources V1 and V2 for supplying a power supply signal to the loops 510 and 520, should be separately supplied.

Hereinafter, a method of minimizing interference between two crossed loops without using a switch and a switch control signal in a loop antenna will be described.

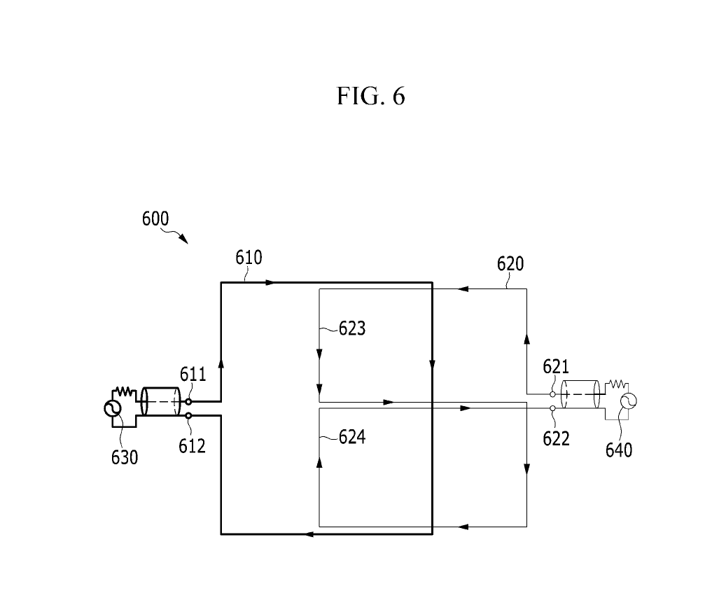

FIG. 6 is a diagram illustrating a loop antenna according to another exemplary embodiment of the present invention. In FIG. 6, an arrow represents a direction of a current.

Referring to FIG. 6, a loop antenna 600 includes two loops 610 and 620 and voltage sources 630 and 640.

The two loops 610 and 620 are partially crossed.

The loop 610 is formed by winding one conductive wire one or more times in a circular or quadrangular form. One terminal of the conductive wire forms an input terminal 611 of the loop 610, and another terminal of the conductive wire forms an output terminal 612 of the loop 610.

The loop 620 is formed by winding one conductive wire one or more times in a circular or quadrangular form in an opposite direction. One terminal of the conductive wire forms an input terminal 621 of the loop 620, and another terminal of the conductive wire forms an output terminal 622 of the loop 620. In this case, the loop 620 includes a double loop, i.e., two sub-loops 623 and 624 having current paths of opposite directions, unlike the loop 610. That is, the loop 620 may be formed with two sub-loops 623 and 624 that are formed by winding one conductive wire in an figure-8 shape.

In this case, the loops 610 and 620 may be formed with a single coil or multiple coils, as shown in FIG. 6.

The voltage sources 630 and 640 alternately supply a power supply signal to the loops 610 and 620.

In such a loop antenna 600, when a power supply signal is applied to the input terminal 611, a current flows to the loop 610, and in this case, electromotive forces that are induced to sub-loops 623 and 624 have the same magnitude and opposite phases. Therefore, electromotive forces that are induced to sub-loops 623 and 624 are offset and thus an induction current does not flow to the loop 620.

Further, when a power supply signal is applied to the input terminal 621, a current flows to the loop 620, and in this case, magnetic fields that are generated by the sub-loop 623 and the sub-loop 624 have the same magnitude and opposite phases and thus an induction current does not flow to the loop 610.

Therefore, the loop antenna 600 does not require a separate switch and a switch control signal for removing interference between loops, as shown in FIG. 5.

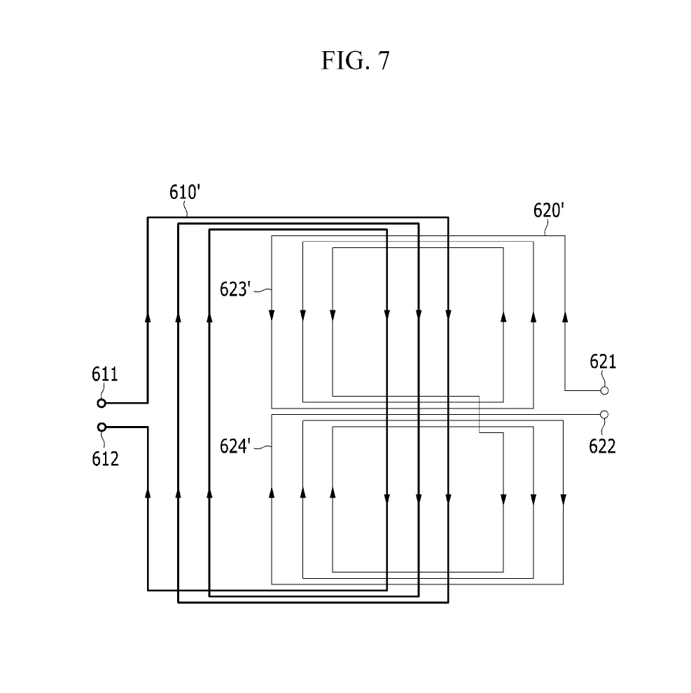

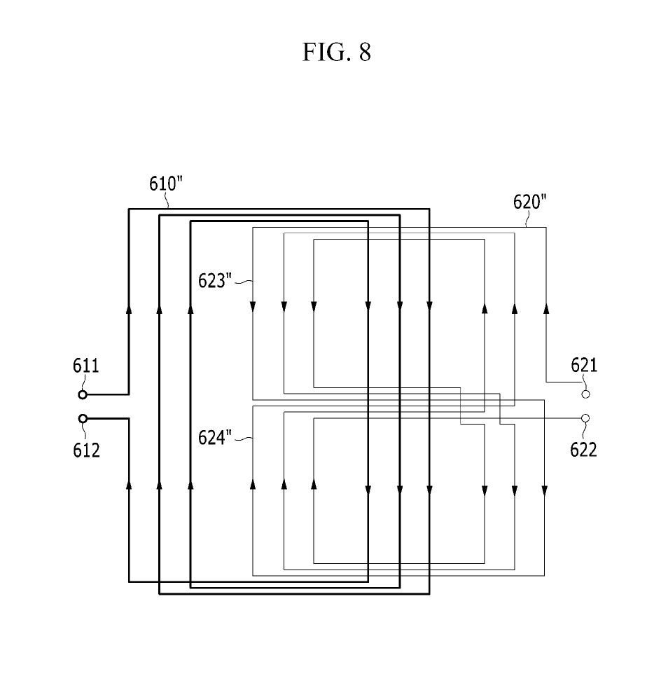

FIGS. 7 and 8 are each diagrams illustrating an exemplary variation of the loop antenna of FIG. 6.

As shown in FIGS. 7 and 8, loops 610′ 610″, 620′, and 620″ may be formed with multiple coils.

The multiple coils are formed by winding one conductive wire several times.

In this case, in a method of forming the loop 620 with multiple coil, a sub-loop 623′ is formed by winding a conductive wire three times and then a sub-loop 624′ is formed by winding the conductive wire three times, as shown in FIG. 7.

Alternatively, sub-loops 623″ and 624″ may be formed by winding a conductive wire in an figure-8 shape, as shown in FIG. 8.

According to an exemplary embodiment of the present invention, interference between two crossed loops without using a switch and a switch control signal can be minimized.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A loop antenna comprising:
a first loop that is formed with one conductive wire; and
a second loop that is formed with another conductive wire and that partially intersects the first loop,
wherein the second loop forms a current path having the same magnitude and an opposite phase to that of the first loop.

2. The loop antenna of claim 1, wherein the second loop has a figure-8 shape.

3. The loop antenna of claim 1, wherein the second loop comprises a double loop forming current paths of opposite directions.

4. The loop antenna of claim 1, wherein the first loop and the second loop are formed with a single coil or multiple coils.

5. The loop antenna of claim 1, further comprising first and second voltage sources that alternately supply a power supply signal to the first loop and the second loop, respectively.

6. A loop antenna, comprising:
a first loop that is formed with one conductive wire;
a second loop that forms a double loop having a current path of an opposite direction with another conductive wire and that partially intersects the first loop; and
a voltage source that alternately supplies a power supply signal to each of the first loop and the second loop.

7. The loop antenna of claim 6, wherein the first loop and the second loop are formed with a single coil or multiple coils.
